(19) United States
(12) Patent Application Publication
(10) Pub. No.: US 2013/0099893 A1
(43) Pub. Date: Apr. 25, 2013

(54) LOCK CONTROL SYSTEM USING RFID

(71) Applicants: Joseph M. Kulinets, Melrose, MA (US); Peter R. Nuytkens, Melrose, MA (US); Arvind K. Venkatesh, (US)

(72) Inventors: Joseph M. Kulinets, Melrose, MA (US); Peter R. Nuytkens, Melrose, MA (US); Arvind K. Venkatesh, (US)

(73) Assignee: Q Developments, LLC, Melrose, MA (US)

(21) Appl. No.: 13/474,034

(22) Filed: May 17, 2012

Related U.S. Application Data
(63) Continuation of application No. PCT/US2010/057082, filed on Nov. 17, 2010.
(60) Provisional application No. 61/262,080, filed on Nov. 17, 2009.

(51) Int. Cl. G05B 1/01

(52) U.S. Cl. CPC G05B 1/01
USPC 340/5.61

(57) ABSTRACT

A lock control system includes a detection unit positioned proximate to a lock, an RFID device neighboring at least one RFID antenna, and an RFID reading system detecting identifying information of the RFID device when the detection unit detects an event. The system also includes at least one microcontroller that determines, based on the identifying information, whether to grant the RFID device access to an area secured by the lock and instructs an actuator to unlock the lock when the RFID device is granted access.

### RELATED APPLICATION

The present application claims priority to U.S. patent application Ser. No. 61/262,080, entitled “Door Lock Using RFID” and filed on Nov. 17, 2009, which is incorporated herein by reference in its entirety.

### BACKGROUND

The present disclosure relates generally to lock control systems and in particular to lock control systems using RFID.

### SUMMARY

In one aspect, the present disclosure is directed to a lock control system. The lock control system includes a detection unit positioned proximate to a lock, an RFID device neighboring at least one RFID antenna, and an RFID reading system detecting identifying information of the RFID device when the detection unit detects an event. The system also includes at least one microcontroller that determines, based on the identifying information, whether to grant the RFID device access to an area secured by the lock and instructs an actuator to unlock the lock when the RFID device is granted access.

The detection unit can be one of a touch sensor and a motion processing module. The motion processing module can include a passive infrared sensor. The microcontroller can activate the RFID reading system to detect identifying information when the detection unit detects the event. The microcontroller can determine whether to grant the RFID device access by matching the identifying information of the RFID devices with identifying information stored in the RFID reading system.

The lock control system can include a second microcontroller in communication with the at least one microcontroller, the second microcontroller instructing the actuator to unlock the lock in response to an instruction from the at least one microcontroller. The at least one microcontroller and the second microcontroller can communicate via infrared or RF wireless communication.

In another aspect, the present disclosure is directed to another lock control system. The lock control system includes a sensor positioned proximate to a lock, and an RFID reading system that detects identifying information of an RFID device when the sensor detects an event, the RFID device neighboring at least one RFID antenna of the RFID reading system. The system includes a microcontroller in communication with an actuator, the microcontroller activating the actuator when the microcontroller matches the identifying information of the RFID device with identifying information stored in the RFID reading system. Activating the actuator can unlock the lock. The event can correspond to motion of a target, the target being associated with the RFID device.

In another aspect, the present disclosure is directed to a method of operating a lock control system. The method includes detecting, by a detection unit, an event. The method includes detecting, by an RFID reading system, identifying information of an RFID device neighboring a RFID antenna in response to the event. The method includes determining, by a microcontroller, to grant access to an area secured by a lock control system based on the identifying information. The method includes instructing, by the microcontroller, an actuator to unlock a lock based on the determination to grant access.

Detecting an event can include detecting, by a touch sensor, a touch. Detecting an event can include detecting, by a motion processing module, motion. Detecting identifying information can include activating, by the microcontroller, the RFID reading system to detect the identifying information. Determining to grant access can include matching, by the microcontroller, the detected identifying information with identifying information stored in the RFID reading system. Instructing an actuator can include receiving, by a second microcontroller, an instruction from the microcontroller to grant access to an area; and instructing, by the second microcontroller, the actuator to unlock the lock.

### BRIEF DESCRIPTION OF THE DRAWINGS

The features of the lock control system and method will be described with reference to the figures, wherein:

FIGS. 1-3 illustrate exemplary block diagrams of lock control systems with a single microcontroller that operates the lock actuator;

FIG. 4 is an illustration of the positioning of a lock control system of FIG. 1 or 2 in a doorway;

FIGS. 5 and 6 illustrate exemplary block diagrams of lock control systems with more than one microcontroller that communicate to operate the lock actuator;

FIG. 7 is an illustration of the positioning of a lock control system of FIG. 4 or 5 in a doorway;

FIG. 8 is an exemplary RFID device used with a lock control system;

FIGS. 9A and 9B illustrate lock control systems that operate a lock actuator by sensing motion; and

FIG. 10 illustrates a lock control system that operates a lock actuator by sensing touch.

### DETAILED DESCRIPTION

The present disclosure is directed to lock control systems using RFID and methods of using the same. A lock control system can use motion detection or touch sensing to detect the presence of a person. In response, the system can obtain identifying information of neighboring RFID devices. If the identifying information of a neighboring RFID device indicates the holder of the device is authorized to access an area secured by the lock control system, the lock control system operates an actuator to unlock the lock.

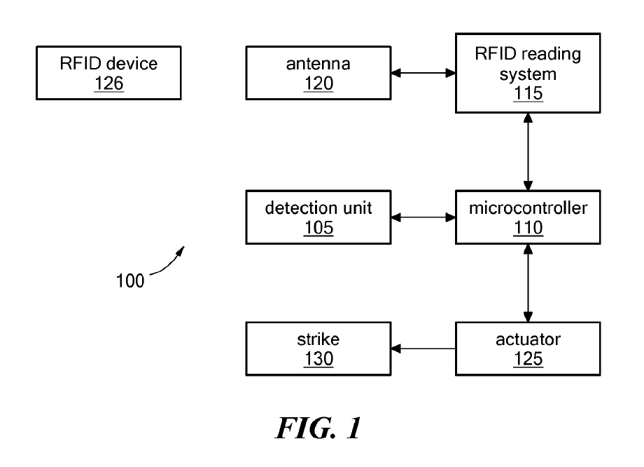

Referring now to FIG. 1, a lock control system 100 with a single microcontroller that operates a lock actuator is shown and described. A detection unit 105 can be positioned near a doorway, by way of example. When the detection unit 105 detects an event, such as motion or touch that indicates a person has approached, the detection unit 105 can transmit a signal to a microcontroller 110. In response, the microcontroller 110 can activate the RFID reading system 115. The RFID reading system 115 can instruct the antenna 120 (e.g., an RFID directional antenna) to search for RFID devices 126 neighboring the antenna 120. If the antenna 120 detects an RFID device 126, the antenna 120 can obtain identifying information of the RFID device 126 and transmit the information to the RFID reading system 115. The RFID reading system 115 can forward the information to the microcontroller 110. The microcontroller 110 can compare the information against the information for RFID devices associated with people authorized to access an area secured by the lock control system. If the microcontroller 110 determines access should be granted, the microcontroller 110 can instruct the actuator 125 to unlock the lock 130.

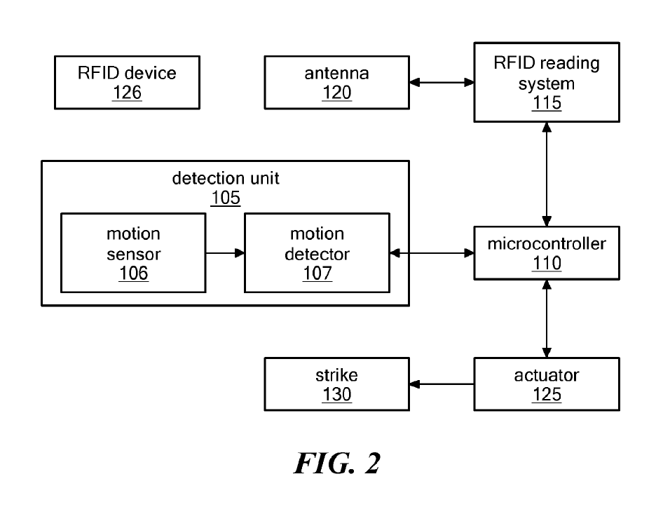

In further detail, the detection unit 105 can detect a person by motion detection, touch sensing, or any other method as would be appreciated by one of ordinary skill in the art. In the lock control system of FIG. 2, the detection unit 105 includes a motion processing module with a motion sensor 106 and a motion detector 107. Exemplary motion sensors 106 can include passive infrared (PIR) sensors, ultrasonic sensors, or microwave sensors. The motion detector 107 can process information gathered by the sensor 106 to determine if sufficient, rather an ambient, motion has occurred to conclude a person has approached the lock control system 100. If so, the motion detector 107 can transmit a signal to the microcontroller 110.

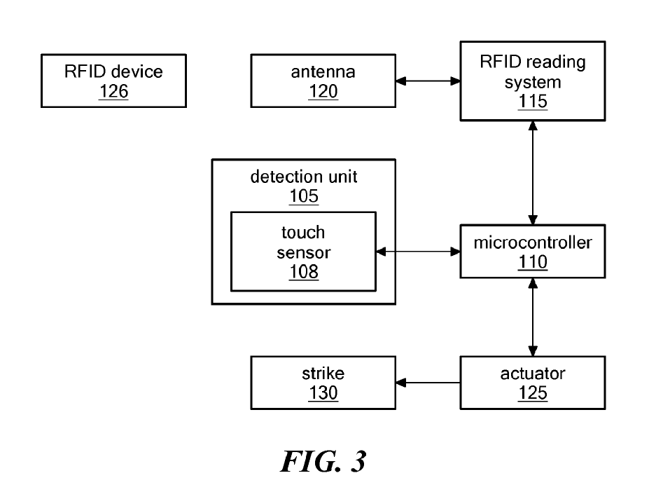

In the lock control system of FIG. 3, the detection unit 105 includes a touch sensor 108. Exemplary touch sensors 108 can include capacitance touch sensors and resistance touch sensors. A touch sensor can be connected to a door knob or handle on the outside side of a door to detect the touch of the incoming person. The touch sensor 108 can require a threshold level of pressure for activation. In this manner, the touch sensor 108 can require sufficient pressure to conclude a person has actively touched the sensor 108. Then, the touch sensor 108 can transmit a signal to the microcontroller 110.

The microcontroller 110 can have two modes of operation, “asleep” and “awake.” In various embodiments, the microcontroller 110 can transition to the “asleep” mode after a predetermined period of inactivity, thereby reducing power consumption. The predetermined period can be 2, 5, 10, 15, 30, or 60 minutes, or any length of time preferred by one of ordinary skill in the art. In response to a signal from the detection unit 105 (e.g., either the motion detector 107 or the touch sensor 108), the microcontroller 110 can transition to an “awake” mode and transmit a signal to activate the RFID reading system 115. Thereafter, the microcontroller 110 can remain in the “awake” mode for the predetermined period of inactivity, after which the microcontroller 110 transitions back to the “asleep” mode.

In response to activation by the microcontroller 110, the RFID reading system 115 can instruct the antenna 120 to search for RFID devices 126. In some embodiments, the RFID reading system 115 delivers power to the antenna 120. Then, the antenna 120 broadcasts power via RF waves to RFID devices 126 neighboring the antenna 120. The broadcasted RF waves can power the RFID devices 126, which transmit their identifying information to the antenna 120. In further embodiments, the RFID reading system 115 sends out a request for identifying information to RFID devices 126 in its neighborhood. Any RFID device 126 that receives the request broadcasts its identifying information in response. The RFID reading system 115 forwards identifying information of detected RFID devices 126 to the microcontroller 110.

The microcontroller 110 can compare the identifying information against information for RFID devices 126 associated with people authorized to access an area secured by the lock control system. In some embodiments, the information for authorized devices and/or people is a list of registered keys. In further embodiments, the information is a list of serial numbers recorded on RFID devices' tag chips. The identifying information can be stored in the RFID reading system. If the identifying information the microcontroller 110 receives matches an entry in the list, the microcontroller 110 can determine access should be granted. In response, the microcontroller 110 electrically communicates with the actuator 125, which unlocks the strike 130 (also referred to herein as a “lock”) to grant access to a secured area.

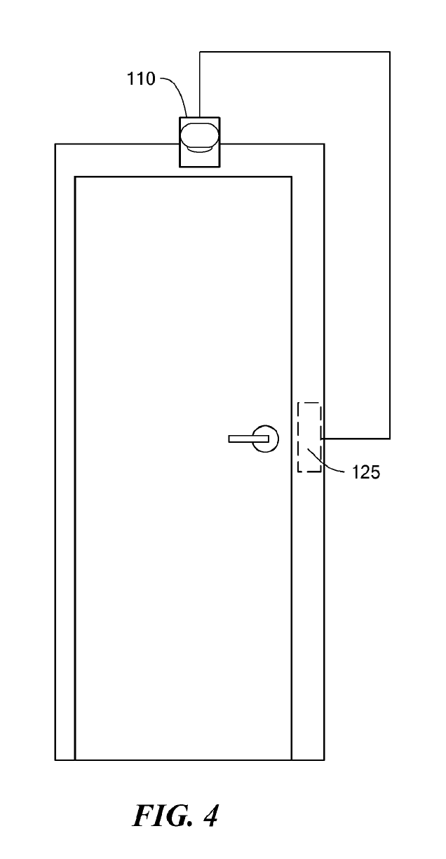

Referring now to FIG. 4, an illustration of the positioning of a lock control system of FIG. 1 or 2 in a doorway is shown and described. The actuator 125 and strike 130 are positioned against the lock at the door frame. The microcontroller 110 and other components of the system 100 are positioned over the door frame. The microcontroller is electrically connected to the actuator 125, thereby directly instructing the actuator 125 to unlock the strike 130.

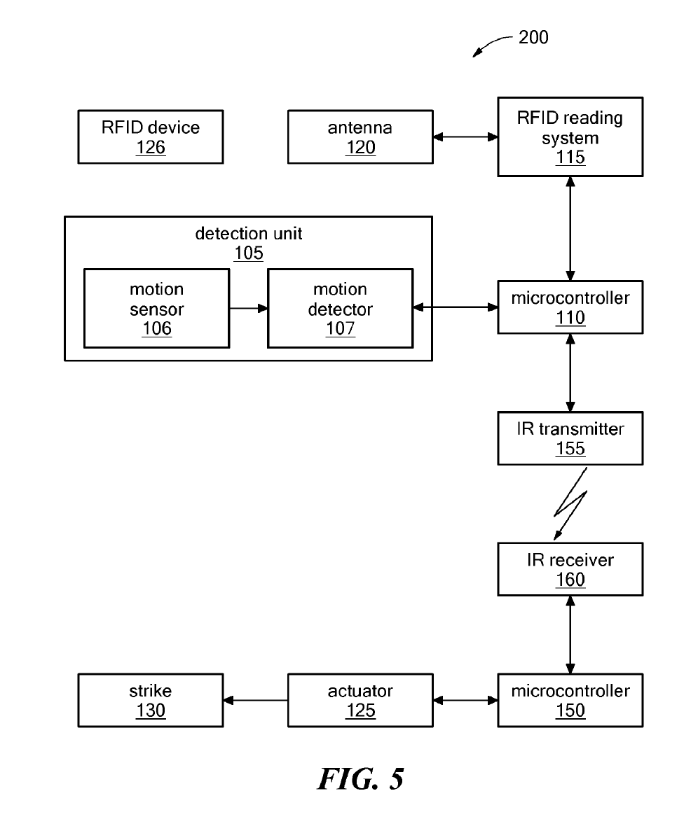

Referring now to FIG. 5, an exemplary block diagram of a lock control system 200 with more than one microcontroller that communicate to operate the lock actuator are shown and described. The lock control system 200 duplicates most of the components of lock control system 100. However, in this system 200, a separate microcontroller 150 communicates with the actuator 125 to unlock the strike 130. Microcontroller 110 is connected to an IR transmitter 155 and microcontroller 150 is connected to an IR receiver 160 to achieve optical infrared (IR) communication.

Similar to the lock control system 100, the motion sensor 106 and motion detector 107 detect motion to wake up microcontroller 110. The microcontroller 110 activates the RFID reading system 115 to obtain identifying information of neighboring RFID devices 126. The microcontroller 110 determines if the RFID device 126 should be granted access to an area secured by the lock. If so, the microcontroller 110 transmits an instruction to unlock the lock to the IR transmitter 155. The IR transmitter 155 broadcasts the instruction to the IR receiver 160, which sends the instruction to the microcontroller 150. In response, the microcontroller 150 electrically communicates with the actuator 125, which unlocks the strike 130 to grant access to a secured area. In some embodiments, receipt of the instruction transitions the microcontroller 150 from an “asleep” mode to an awake “mode,” as described in reference to FIGS. 1-3.

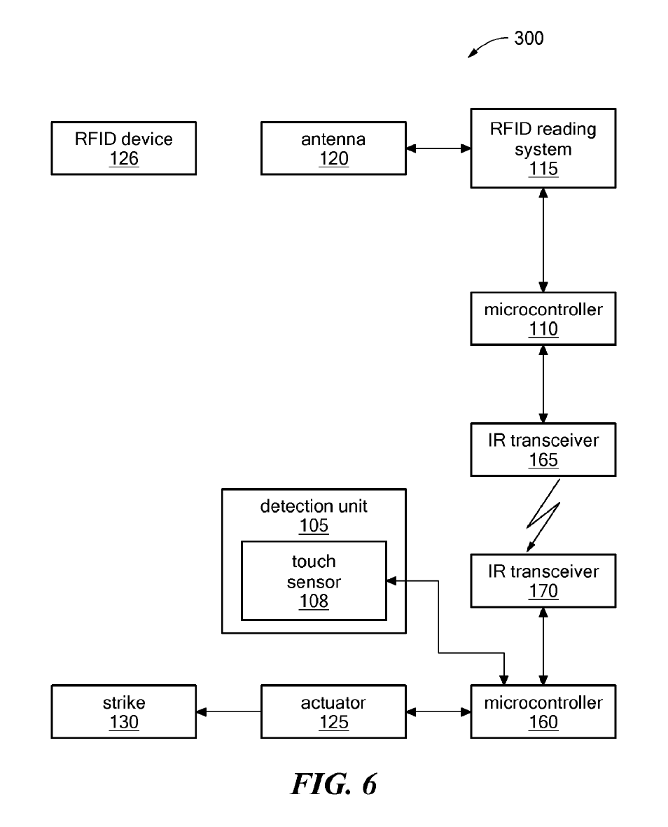

Referring now to FIG. 6, an exemplary block diagram of a lock control system 300 with more than one microcontroller that communicate to operate the lock actuator are shown and described. The lock control system 300 duplicates most of the components of lock control system 200. However, in this system 300, the detection unit 105 is a touch sensor 108 that communicates with microcontroller 160 instead of microcontroller 110. Further, each microcontroller 110, 160 is connected to an IR transceiver 165, 170, thereby enabling two-way communication between the microcontrollers 110, 160.

In operation, the touch sensor 108 transmits a signal to the microcontroller 160 upon detection of touch. The signal from the sensor 108 awakens the microcontroller 160. The microcontroller 160 transmits an instruction to detect neighboring RFID devices 126 to microcontroller 110 via the transceivers 165, 170. The instruction can awaken the microcontroller 110, which activates the RFID reading system 115 to detect identifying information of neighboring RFID devices 126. If the identifying information matches information for RFID devices 126 associated with people authorized to access an area secured by the lock control system, the microcontroller 110 instructs microcontroller 160, via transceivers 165 and 170, to unlock the lock. In response, the microcontroller 150 electrically communicates with the actuator 125, which unlocks the strike 130 to grant access to a secured area.

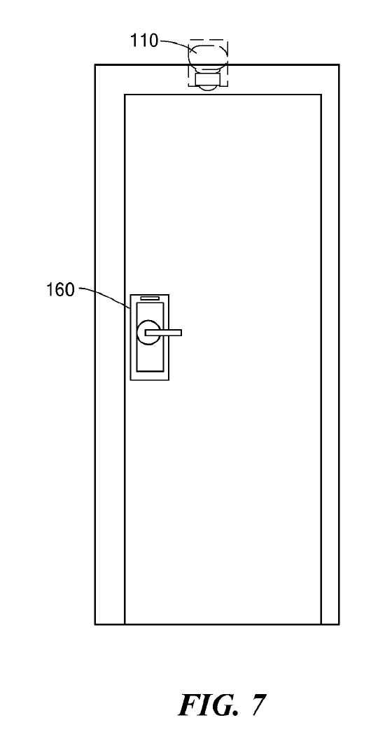

Referring now to FIG. 7, an illustration of the positioning of a lock control system of FIG. 5 or 6 in a doorway is shown and described. The IR transceiver 170, microcontroller 160, and strike 130 are positioned against the lock at the door frame. The microcontroller 110 and IR transceiver 165 are positioned over the door frame. The microcontrollers 110, 160 are connected via IR or other wireless (e.g., RF) communication to unlock the strike 130.

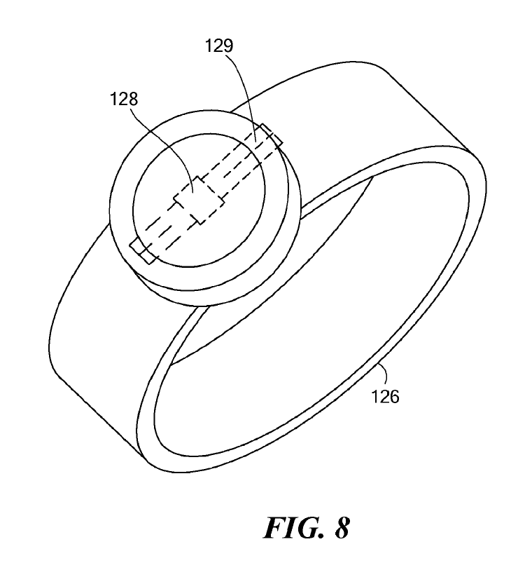

Referring now to FIG. 8, an exemplary RFID device 126 is shown and described. The RFID device 126 can include an RFID tag 128 (also referred to herein as a “tag chip”) and an antenna 129. Each RFID device 126 can be pre-recorded with identifying information, such as a serial number, on the tag chip 128. The identifying information can be pre-recorded in the tag chip 128 during manufacture. The RFID device 126 can take the form of a wristband or any other form as would be evident to one of ordinary skill in the art. In some embodiments, the RFID device 126 is a passive ultra-high frequency (UHF) RFID device.

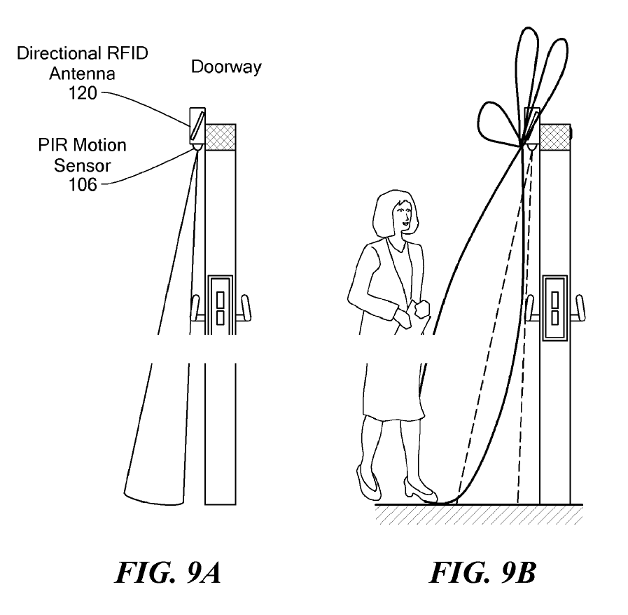

Referring now to FIGS. 9A and 9B, a lock control system that operates a lock actuator by sensing motion is shown and described. In this system, the antenna 120 and motion sensor 106 are positioned over the door. The motion sensor 106 detects any motion within a predetermined area. When a person walks into the predetermined area, as demonstrated in FIG. 9B, the motion detector 107 wakes up the microcontroller 110, and the microcontroller 110 activates the RFID reading system 115 to detect identifying information of neighboring RFID devices 126. If the person has an RFID device 126 authorized to access a secured area, the system unlocks the lock.

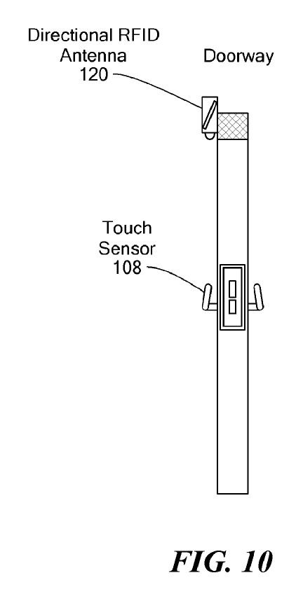

Referring now to FIG. 10, a lock control system that operates a lock actuator by sensing touch is shown and described. In this system, the antenna 120 is positioned over the door and the touch sensor 108 is connected to a door knob or handle on the outside side of a door. The touch sensor 108 detects any touch from an approaching person and wakes up the microcontroller 110. The microcontroller 110 activates the RFID reading system 115 to detect identifying information of neighboring RFID devices 126. If the person has an RFID device 126 authorized to access a secured area, the system unlocks the lock.

While the invention has been particularly shown and described with reference to specific embodiments, it should be understood by those skilled in the art that various changes in form and detail may be made therein without departing from the spirit and scope of the invention as defined by the appended claims.

What is claimed:

1. A lock control system, the system comprising:
a detection unit positioned proximate to a lock;
an RFID device neighboring at least one RFID antenna;
an RFID reading system detecting identifying information of the RFID device when the detection unit detects an event; and
at least one microcontroller that determines, based on the identifying information, whether to grant the RFID device access to an area secured by the lock and instructs an actuator to unlock the lock when the RFID device is granted access.

2. The system of claim 1, wherein the detection unit is one of a touch sensor and a motion processing module.

3. The system of claim 2, wherein the motion processing module includes a passive infrared sensor.

4. The system of claim 1, wherein the microcontroller activates the RFID reading system to detect identifying information when the detection unit detects the event.

5. The system of claim 1, wherein the microcontroller determines whether to grant the RFID device access by matching the identifying information of the RFID devices with identifying information stored in the RFID reading system.

6. The system of claim 1, further comprising a second microcontroller in communication with the at least one microcontroller, the second microcontroller instructing the actuator to unlock the lock in response to an instruction from the at least one microcontroller.

7. The system of claim 6, wherein the at least one microcontroller and the second microcontroller communicate via infrared or RF wireless communication.

8. A lock control system, the system comprising:
a sensor positioned proximate to a lock;
an RFID reading system that detects identifying information of an RFID device when the sensor detects an event, the RFID device neighboring at least one RFID antenna of the RFID reading system; and
a microcontroller in communication with an actuator, the microcontroller activating the actuator when the microcontroller matches the identifying information of the RFID device with identifying information stored in the RFID reading system.

9. The system of claim 8, wherein activating the actuator unlocks the lock.

10. The system of claim 9, wherein the event corresponds to motion of a target, the target being associated with the RFID device.

11. A method of operating a lock control system comprising:
detecting, by a detection unit, an event;
detecting, by an RFID reading system, identifying information of an RFID device neighboring a RFID antenna in response to the event;
determining, by a microcontroller, to grant access to an area secured by a lock control system based on the identifying information; and
instructing, by the microcontroller, an actuator to unlock a lock based on the determination to grant access.

12. The method of claim 11, wherein detecting an event further comprises detecting, by a touch sensor, a touch.

13. The method of claim 11, wherein detecting an event further comprises detecting, by a motion processing module, motion.

14. The method of claim 11, wherein detecting identifying information further comprises activating, by the microcontroller, the RFID reading system to detect the identifying information.

15. The method of claim 11, wherein determining to grant access further comprises matching, by the microcontroller, the detected identifying information with identifying information stored in the RFID reading system.

16. The method of claim 11, wherein instructing an actuator further comprises
receiving, by a second microcontroller, an instruction from the microcontroller to grant access to an area; and
instructing, by the second microcontroller, the actuator to unlock the lock.
